(19) United States
(12) Patent Application Publication
(10) Pub. No.: US 2021/0294289 A1
(43) Pub. Date: Sep. 23, 2021

(54) METHOD FOR DETECTING INTEGRITY INDEX OF DRIVING UNIT

(71) Applicant: ITS CO., LTD., Ulsan (KR)

(72) Inventor: Young Kyu Lee, Ulsan (KR)

(21) Appl. No.: 17/330,539

(22) Filed: May 26, 2021

(30) Foreign Application Priority Data
Dec. 27, 2018 (KR) 10-2018-0171364

(51) Int. Cl. G05B 19/042

(52) U.S. Cl. CPC G05B 19/042; G05B 2219/24008

(57) ABSTRACT

Disclosed is a method for detecting an integrity index of a driving unit, including: an integrity value setting step of setting an integrity reference value on the basis of information on power consumed in a normal driving section of a driving unit; a defective value setting step of setting a defective reference value on the basis of information on power consumed in a driving section of the driving unit before a failure occurs; a measurement value extraction step of extracting a measurement value from information on power consumed in a driving section measured in a real-time driving state of the driving unit; a detection step of comparing the measurement value extracted in the measurement value extraction step with the integrity reference value and the defective reference value and detecting an integrity index value of the driving unit; and an output step of outputting the integrity index value detected in the detection step and providing same to an administrator.

### CROSS-REFERENCE TO RELATED APPLICATIONS

This application is the National Stage filing under 35 U.S.C. 371 of International Application No. PCT/KR2019/014523, filed on Oct. 31, 2019, which claims the benefit of K.R application No. 10-2018-0171364, filed on Dec. 27, 2018, the contents of which are all hereby incorporated by reference herein in their entirety.

### TECHNICAL FIELD

The present disclosure relates to a method for detecting an integrity index of a driving unit, and more particularly, to a method for detecting an integrity index of a driving unit in which: an integrity index reference table may be constructed on the basis of a detection reference value set in a normal driving unit and a defective reference value set in the driving unit that is about to fail; a real-time measurement value of the driving unit may then be applied to the integrity index reference table to output an integrity index value indicating the integrity of the driving unit in real time, and to provide the output value to an administrator; and the administrator may then clearly recognize the real-time integrity of the driving unit by the integrity index, make his/her own plan for the inspection or management of the driving unit, and perform an overall management of the driving unit very actively and reliably, thereby significantly reducing a safety accident and a financial loss which are caused by the sudden failure of the driving unit.

### BACKGROUND ART

In general, it is very important that a driving unit (a motor, a pump, a conveyor, a compressor, etc.) used for an automated process of a facility is stably operated.

For example, hundreds of driving units may be installed in a facility of a large-scale transfer plant and may continuously transfer a material to be transferred while being interlocked with each other, and if a failure occurs in any one of the several driving units, a tremendous problem may occur in which an operation of the facility is entirely stopped.

In this case, downtime may occur due to the failure of the driving unit, which may inevitably cause not only a repairing cost of the driving unit but also a huge loss due to its wasted operating cost and business effect while the operation of the facility is stopped.

According to the latest data from the Ministry of Employment and Labor and the Korea Industrial Safety Management Corporation, the total number of casualties due to occupational safety accidents per year is estimated to be around 100,000, and it is estimated that 18 trillion won per year is incurred when this damage is converted into costs.

As a way to avoid the occurrence of such unexpected downtime costs, urgently required is a method in which information on a state of the driving unit is provided to an administrator in real time, and the driving unit may thus be checked and repaired before the failure occurs therein, thereby inducing an efficient management of the driving unit.

### DISCLOSURE

### Technical Problem

The present disclosure has been proposed to solve all the problems as described above, an object of the present disclosure is to provide a method for detecting an integrity index of a driving unit in which: an integrity index reference table may be constructed on the basis of a detection reference value set in a normal driving unit and a defective reference value set in the driving unit that is about to fail; a real-time measurement value of the driving unit may then be applied to the integrity index reference table to output an integrity index value indicating the integrity of the driving unit in real time, and to provide the output value to an administrator; and the administrator may then clearly recognize the real-time integrity of the driving unit by the integrity index, make his/her own plan for the inspection or management of the driving unit, and perform an overall management of the driving unit very actively and reliably, thereby significantly reducing a safety accident and a financial loss which are caused by the sudden failure of the driving unit.

### Technical Solution

According to an exemplary embodiment of the present disclosure, a method for detecting an integrity index of a driving unit may include: an integrity value setting step of setting an integrity reference value on the basis of information on power consumed in a normally driven section of a driving unit; a defective value setting step of setting a defective reference value on the basis of information on power consumed in a driven section of the driving unit before a failure occurs; a measurement value extraction step of extracting a measurement value from information on power consumed in the driven section measured in a state where the driving unit is driven in real time; a detection step of comparing the measurement value extracted in the measurement value extraction step with the integrity reference value and the defective reference value to detect an integrity index value of the driving unit; and an output step of outputting the integrity index value detected in the detection step and providing the output value to an administrator.

The integrity reference value, the defective reference value and the measurement value may be set to any one selected from: a peak current value and an integral area value capable of being extracted from information on change in a magnitude of a current over time in the driven section of the driving unit, and a time interval value in which the driven section is maintained.

A start point may be a point where a current value consumed by the driving unit is greater than a set offset value, an end point may be a point where the current value is less than the offset value, and the driven section may be set from the start point to the end point.

Information on change in a magnitude of a current of the driving unit over time may be forcibly divided based on a set time interval, and the divided section may be set to the driven section.

The detection step may include: a division process of dividing a section between the integrity reference value set in the integrity value setting step and the defective reference value set in the defective value setting step into at least two sections; a setting process of setting the divided sections between the integrity reference value and the defective reference value sequentially as the first section, the second section, . . . , and the n-th section starting from the integrity reference value, and simultaneously constructing an integrity index reference table by setting the integrity index value for each section; and a detection process of detecting a section to which the measurement value corresponds, by applying the measurement value extracted in the measurement value extraction step to the integrity index reference table, and extracting the integrity index value of the detected section.

### Advantageous Effects

As set forth above, according to the method for detecting an integrity index of a driving unit of the present disclosure, an integrity index reference table may be constructed on the basis of the detection reference value set in a normal driving unit and a defective reference value set in the driving unit that is about to fail; a real-time measurement value of the driving unit may then be applied to the integrity index reference table to output an integrity index value indicating the integrity of the driving unit in real time, and to provide the output value to an administrator; and the administrator may then clearly recognize the real-time integrity of the driving unit by the integrity index, make his/her own plan for the inspection or management of the driving unit, and perform an overall management of the driving unit very actively and reliably, thereby significantly reducing a safety accident and a financial loss which are caused by the sudden failure of the driving unit.

### DESCRIPTION OF DRAWINGS

FIG. 1 is a flowchart illustrating a method for detecting an integrity index of a driving unit according to an exemplary embodiment of the present disclosure.

FIG. 2 is a view illustrating information on power over time in a normally driven section of a driving unit.

FIG. 3 is a view illustrating information on power over time in the driven section of the driving unit that is about to fail.

FIG. 4 is a view illustrating a divided section between an integrity reference value and a defective reference value.

FIG. 5 is a view illustrating that the section between the integrity reference value and the defective reference value is divided into 10 sections.

FIG. 6 is a view illustrating a process of extracting an integrity index value from a measurement value.

FIG. 7 is a view illustrating that the driven section is set according to an exemplary embodiment of the present disclosure.

FIG. 8 is a view illustrating that the driven section is set according to another exemplary embodiment of the present disclosure.

### BEST MODE

It is to be noted that technical terms used in the present disclosure are used in order to describe only specific exemplary embodiments rather than restricting the present disclosure. In addition, unless indicated otherwise in the specification, it is to be understood that the technical terms used in the specification are construed as meaning as those that are generally understood by those who are skilled in the art, and are not construed as excessively comprehensive meanings or excessively reduced meanings. In addition, when the technical terms used in the specification are wrong technical terms that do not accurately indicate the technical spirit of the present disclosure, it is to be understood that the terms are replaced with the technical terms understood by those skilled in the art.

Further, the general terms used in the present disclosure need to be understood according to the terms defined by the dictionary or the context and should not be excessively reduced meanings.

In addition, singular forms used in the specification are intended to include plural forms unless the context clearly indicates otherwise. In the specification, it is to be noted that the terms “comprise,” “include” and the like are not be construed as necessarily including all of the various components or steps described in the specification, and it is to be construed that some of the above components or steps may not be included or may further include additional components or steps.

Hereinafter, the present disclosure is described in more detail through an exemplary embodiment, and the scope of the present disclosure is not limited thereto.

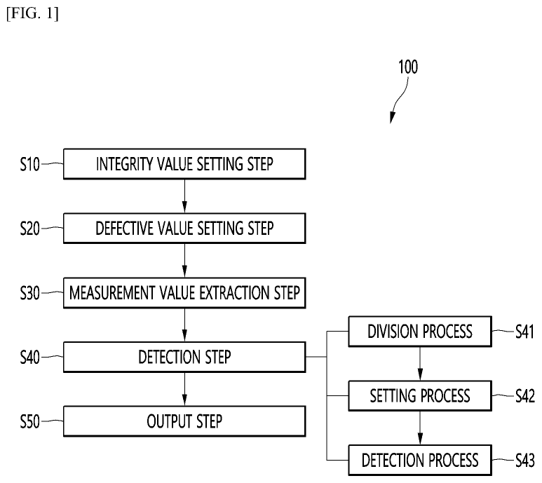

FIG. 1 is a flowchart illustrating a method for detecting an integrity index of a driving unit according to an exemplary embodiment of the present disclosure.

As illustrated in the above drawing, the method for detecting an integrity index of a driving unit 100 according to an exemplary embodiment of the present disclosure includes an integrity value setting step S10, a defective value setting step S20, a measurement value extraction step S30, a detection step S40 and an output step S50.

The integrity value setting step S10 of FIG. 1 is a step of setting an integrity reference value on the basis of information on power consumed in a normally driven section of a driving unit.

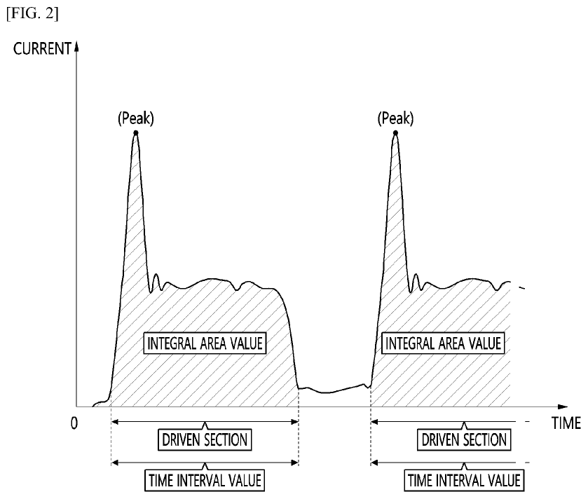

FIG. 2 is a view illustrating the information on the power over time in the normally driven section of the driving unit.

Referring to FIG. 2, a peak current value, an integral area value, and a time interval value in which the driven section is maintained may be extracted from the information on the power in the normally driven section of the driving unit, respectively, and the integrity reference value is set on the basis of the extracted value extracted in such a manner.

For example, the integrity reference value may be set to an average value of the extracted values that are continuously extracted.

Here, the integrity reference value may be set by selecting any one of the peak current value, integral area value and time interval value in the driven section; the same type of values may be selectively applied for the value selected in this manner, a defective reference value in the defective value measuring step S20, and the extracted value in the measurement value extraction step S30, which are to be described below; and the integrity reference value, the defective reference value and the extracted value may be clearly compared with each other, thereby securing reliability of a result value detected in the detection step S40 to be described below.

For example, in a case where the peak current value of the driving unit is selectively used as the integrity reference value, the peak current value of the driving unit may also be selectively used as the defective reference value and the measurement value.

Here, the peak current value may refer to a current value having a maximum(peak) magnitude in the driven section of the driving unit.

The defective value setting step S20 of FIG. 1 is a step of setting the defective reference value on the basis of information on power consumed in a driven section of the driving unit that is about to fail.

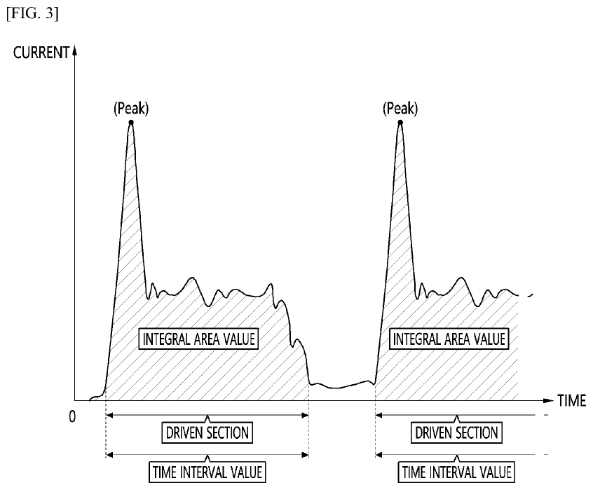

FIG. 3 is a view illustrating the information on the power over time in the driven section of the driving unit that is about to fail.

Referring to FIG. 3, the peak current value, the integral area value, and the time interval value in which the driven section is maintained, may be extracted from the information on the power in the driven section of the driving unit that is about to fail, respectively, and the defective reference value may be set on the basis of the extracted value extracted in such a manner.

Here, when comparing the information on the power in the driven section shown in FIG. 3 with the information on the power in the driven section shown in FIG. 2, it may be noted that the consumed amount of power (integral area value), the peak power value and the time interval value, in the driven section of the driving unit that is about to fail is increased compared to the consumed integral area value, the peak power value and the time interval value, in the normally driven section of the driving unit.

Therefore, it may be noted that the amount of power, the peak power value and the time interval value are formed somewhat abnormally (unstably) in the driving unit that is about to fail.

The measurement value extraction step S30 of FIG. 1 is a step of extracting a measurement value from information on power consumed in the driven section measured in a state where the driving unit is driven in real time.

Here, the extracted measurement value is a value used in the detection step S40 to detect the integrity of the driving unit in real time, and is described in detail in the detection step S40.

The detection step S40 of FIG. 1 is a step of comparing the measurement value extracted in the measurement value extraction step with the integrity reference value and the defective reference value to detect an integrity index value of the driving unit, and includes a division process S41, a setting process S42 and a detection process S43.

The division process S41 is a process of dividing a section between the integrity reference value set in the integrity value setting step S10 and the defective reference value set in the defective value setting step S20 into at least two sections.

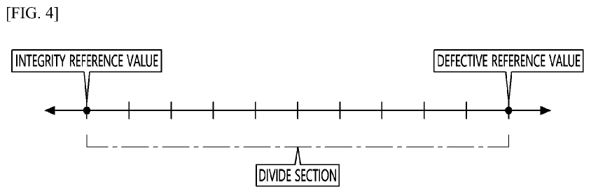

FIG. 4 is a view illustrating the divided section between the integrity reference value and the defective reference value.

Referring to FIG. 4, the integrity reference value and the defective reference value have a difference in value (size), a section between the integrity reference value and the defective reference value is formed by the difference, and the section is divided into the at least two sections each having the same interval.

Here, the division between the integrity reference value and the defective reference value may have the number of the divided sections set based on how precisely the integrity of the driving unit is to be detected in the detection process S43 to be described below. For example, it is possible to more accurately detect the integrity of the driving unit by dividing a section between the integrity reference value and the defective reference value into 100 sections rather than 10 sections.

The method for detecting an integrity index of the driving unit 100 of the present disclosure divides the section between the integrity reference value and the defective reference value into 10 sections, and the number of the divided sections is not limited thereto.

The setting process S42 is a process of setting the divided sections between the integrity reference value and the defective reference value sequentially as the first section, the second section, . . . , and the n-th section starting from the integrity reference value, and simultaneously constructing an integrity index reference table by setting the integrity index value for each section.

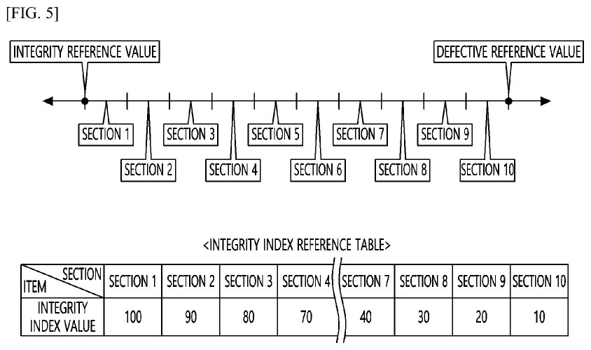

FIG. 5 is a view illustrating that the section between the integrity reference value and the defective reference value is divided into 10 sections.

Referring to FIG. 5, when the section between the integrity reference value and the defective reference value is divided into 10 sections in the division process, the divided sections may then be set to the first section, the second section, . . . , and the 10th section starting from the integrity reference value, and the integrity index reference table may be constructed by setting the integrity index value for each section. In the method for detecting an integrity index of the driving unit 100 of the present disclosure, the integrity index value may be limited to a range from a minimum of 10 to a maximum of 100, and the limited integrity index value may be assigned to each section to detect the integrity of the driving unit.

Here, the integrity index value may be limited to the range of 10 to 100, and it is set that the driving unit may be in an integrity state if the integrity index value is high, and the driving unit may be in a defective state if the integrity index value is low. However, the range limitation and setting of the integrity index value are arbitrarily set to illustrate an example, and the integrity index value may be set in various ranges and settings.

The detection process S43 is a process of detecting a section to which the measurement value corresponds, by applying the measurement value extracted in the measurement value extraction step S30 to the integrity index reference table, and extracting the integrity index value of the detected section.

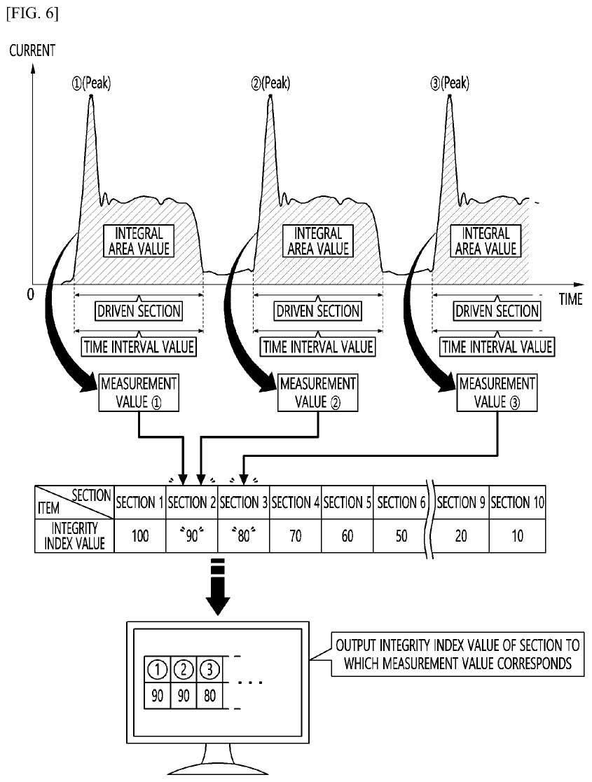

FIG. 6 is a view illustrating a process of extracting the integrity index value from the measurement value.

Referring to FIG. 6, the measurement values may be continuously extracted from the driven section of the driving unit that is driven in real time, the extracted measurement value may be applied to the integrity index reference table to detect the corresponding section, and the integrity index value corresponding to the detected section is extracted (obtained).

The integrity index value extracted in this manner may indicate that: the closer the integrity index value is to 100, the higher the integrity of the driving unit, and the driving unit is thus in the integrity state; whereas, the closer the integrity index value is to 1, the lower the integrity of the driving unit, and the driving unit is thus in the defective state.

The output step S50 of FIG. 1 is a process of outputting the integrity index value detected in the detection step and providing the output value to an administrator.

That is, when the integrity index value of the driving unit that is driven in real time is extracted in the process of the detection step S40, and the extracted integrity index value may be output as an image on a general monitor, thereby guiding the administrator to clearly recognize the integrity state of the driving unit and to effectively cope with, based on the integrity of the driving unit.

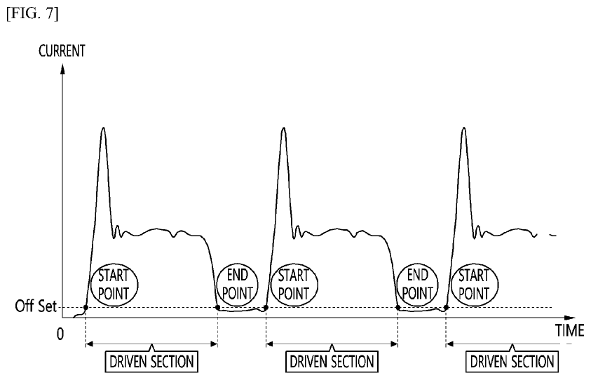

FIG. 7 is a view illustrating that the driven section is set according to an exemplary embodiment of the present disclosure.

Referring to FIG. 7, a start point may be a point where the current value consumed by the driving unit is greater than a set offset value, an end point may be a point where the current value is less than the offset value, and the driven section may be set from the start point to the end point.

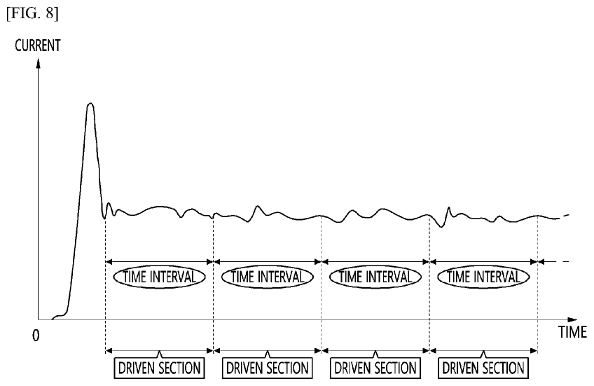

FIG. 8 is a view illustrating that the driven section is set according to another exemplary embodiment of the present disclosure.

Referring to FIG. 8, information on change in a magnitude of the current of the driving unit over time may be forcibly divided based on a set time interval, and the divided section may be set to the driven section.

That is, if the driving unit repeats idle and drive continuously, its driven section may be easily extracted and obtained using the offset value, and if the driving unit is continuously driven without stopping after being driven once, the time interval may be set to forcibly extract its driven section, thereby inducing the integrity of the driving unit to be easily detected under various conditions.

According to the method for detecting an integrity index of the driving unit 100 of the present disclosure, the integrity of the driving unit may be detected in the above processes, the integrity index reference table may be constructed on the basis of the detection reference value set in the normal driving unit and the defective reference value set in the driving unit that is about to fail; the real-time measurement value of the driving unit may then be applied to the integrity index reference table to output the integrity index value indicating the integrity of the driving unit in real time, and to provide the output value to the administrator; and the administrator may then clearly recognize the real-time integrity of the driving unit by the integrity index, make his/her own plan for the inspection or management of the driving unit, and perform an overall management of the driving unit very actively and reliably, thereby significantly reducing a safety accident and a financial loss which are caused by the sudden failure of the driving unit.

Although the specific exemplary embodiments of the present disclosure are illustrated and described hereinabove, the present disclosure is not limited to the above-mentioned specific exemplary embodiments, and may be variously modified by those skilled in the art to which the present disclosure pertains without departing from the scope and spirit of the present disclosure as disclosed in the accompanying claims. These modifications also need to be understood to fall within the scope of the present disclosure.

### INDUSTRIAL APPLICABILITY

The method for detecting an integrity index of a driving unit may be used in an automated process of a facility.

1. A method for detecting an integrity index of a driving unit, the method comprising:
an integrity value setting step of setting an integrity reference value based on information on power consumed in a normally driven section of the driving unit;
a defective value setting step of setting a defective reference value based on information on power consumed in a driven section of the driving unit before a failure occurs;
a measurement value extraction step of extracting a measurement value from information on power consumed in a driven section measured in a state where the driving unit is driven in real time;
a detection step of detecting an integrity index value of the driving unit by comparing the measurement value extracted in the measurement value extraction step with the integrity reference value and the defective reference value; and
an output step of providing the integrity index value detected in the detection step with an administrator by outputting the integrity index value.

2. The method of claim 1, wherein the integrity reference value, the defective reference value and the measurement value are set to any one selected from:
a peak current value and an integral area value capable of being extracted from information on change in a magnitude of a current over time in the driven section of the driving unit, and
a time interval value in which the driven section is maintained.

3. The method of claim 1,
wherein the driven section is set from a start point to an end point, and
wherein the start point is a point where a current value consumed by the driving unit is greater than a set offset value, and the end point is a point where the current value is less than the set offset value.

4. The method of claim 1, wherein information on change in a magnitude of a current of the driving unit over time is forcibly divided based on a set time interval, and the divided section is set to the driven section.

5. The method of claim 1, wherein the detection step includes:
a division process of dividing a section between the integrity reference value set in the integrity value setting step and the defective reference value set in the defective value setting step into at least two sections;
a setting process of setting the divided sections between the integrity reference value and the defective reference value sequentially as the first section, the second section, . . . , and the n-th section starting from the integrity reference value, and simultaneously constructing an integrity index reference table by setting the integrity index value for each section; and
a detection process of detecting a section to which the measurement value corresponds, by applying the measurement value extracted in the measurement value extraction step to the integrity index reference table, and extracting the integrity index value of the detected section.
